(19) United States
(12) Patent Application Publication
(10) Pub. No.: US 2019/0320357 A1
(43) Pub. Date: Oct. 17, 2019

(54) Information Transmission Method and Device

(71) Applicant: Huawei Technologies Co., Ltd., Shenzhen (CN)

(72) Inventors: Da Wang, Shenzhen (CN); Yongbo Zeng, Beijing (CN); Jian Wang, Beijing (CN); Bin Liu, San Diego, CA (US); Yanliang Sun, Shenzhen (CN)

(21) Appl. No.: 16/466,599

(22) PCT Filed: Dec. 5, 2016
(86) PCT No.: PCT/CN2016/108580

§ 371 Date: Jun. 4, 2019

(51) Int. Cl. H04W 36/00; H04W 56/00

(52) U.S. Cl. CPC H04W 36/0077; H04W 84/042; H04W 56/00

(57) ABSTRACT

Embodiments of the present invention provide an information transmission method and a device. The method includes: sending, by a first device, first information to a second device, where the first information includes a cell identity of a first cell, the first cell is a serving cell of the first device, the second device accesses the first cell by using the first device, and the first information is used by the second device to determine the cell identity of the first cell.

### CROSS-REFERENCE TO RELATED APPLICATIONS

This application is a national stage of International Application No. PCT/CN2016/108580, filed on Dec. 5, 2016, which is hereby incorporated by reference in its entirety.

### TECHNICAL FIELD

Embodiments of the present invention relate to the communications field, and in particular, to an information transmission method and a device.

### BACKGROUND

With development of the times, everyone may carry various electronic devices with himself or herself in the future. Some devices (second devices) in the electronic devices may be connected to a network by using some other devices (first devices).

For example, the second devices may be low-capability devices, such as various intelligent wearable devices carried by everyone. The first device may be a high-capability device, for example, an intelligent terminal such as a smartphone. The second device may be connected to the network through relaying by using the first device.

When the second device is connected to the network by using the first device, and when a connection between the second device and the first device is abnormal or the second device is disconnected from the first device, a service (for example, a voice service) on the second device is interrupted, affecting user experience.

Therefore, after the connection between the second device and the first device is abnormal or the second device is disconnected from the first device, how to ensure continuity of the service on the second device is a problem urgently to be resolved.

### SUMMARY

Embodiments of the present invention provide an information transmission method and a device. The method can ensure continuity of a service on a second device, thereby improving user experience.

According to a first aspect, an information transmission method is provided, and the method includes: sending, by a first device, first information to a second device, where the first information includes a cell identity of a first cell, the first cell is a serving cell of the first device, the second device accesses the first cell by using the first device, and the first information is used by the second device to determine the cell identity of the first cell.

Specifically, in the embodiments of the present invention, after the second device connects to the first device, the second device still needs to measure a direct link, so that the second device can quickly switch to the direct link after leaving coverage of the first device, thereby ensuring service continuity.

Therefore, in the embodiments of the present invention, the first device sends the first information to the second device, so that the second device can quickly perform cell measurement based on the first information, and quickly switch from a relay link to the direct link, thereby ensuring continuity of a service on the second device and improving user experience.

It should be noted that in the embodiments of the present invention, the first information may be a system message sent by a network device, or may include the system message, or the first information may be a subset of the system message. The embodiments of the present invention are not limited thereto. Therefore, the first information in the embodiments of the present invention may also be referred to as system information, a system message, system-related information, or the like, and the embodiments of the present invention are not limited thereto.

In the embodiments of the present invention, the first device may send the first information in a broadcast manner, or may send the first information in a device to device (Device to Device, D2D) communication manner, or may send the first information in another short range communication manner. This is not limited in the embodiments of the present invention.

Optionally, in an implementation, the method may further include: the first information is further used by the second device to access the first cell.

Therefore, in the embodiments of the present invention, the first device sends the first information to the second device, so that after being disconnected from the first device, the second device can quickly access the network device based on the received first information, and the second device can switch from the relay link to the direct link, thereby ensuring service continuity.

Optionally, in an implementation, the second device is synchronized with the network device, and the first information further includes at least one of the following information: uplink signal timing advance (Timing Advance, TA) information, time division duplex (Time Division Duplex, TDD) system information or frequency division duplex (Frequency Division Duplex, FDD) system information, a preamble sequence number used for random access, and public land mobile network (Public Land Mobile Network, PLMN) identity information.

The second device can quickly access the network device in a contention-free manner by using the preamble sequence number used for random access.

Specifically, when the first information includes the preamble sequence number, before the first device sends the first information, the first device needs to apply for a preamble sequence in a contention-free group from the network device, and then send a preamble sequence number of the preamble sequence to the second device by using the first information.

The second device directly sends an access signal to the network device by using the uplink signal timing advance TA information, and the network device does not need to indicate the uplink signal timing advance TA information, so that the second device can quickly access the network device.

Specifically, because the first device is relatively close to the second device, the second device may directly send the access signal to the network device by using the uplink signal timing advance TA information of the first device, and the network device does not need to indicate the uplink signal timing advance TA information, so that the second device can quickly access the network device.

The second device recognizes a type of the network device by using the time division duplex TDD system information or the frequency division duplex FDD system information and/or the public land mobile network PLMN identity information, and does not need to re-read system information, so that the second device quickly accesses the network device.

In the embodiments of the present invention, because the first information includes the at least one of the uplink signal timing advance TA information, the time division duplex TDD system information or the frequency division duplex FDD system information, the preamble sequence number used for random access, and the public land mobile network PLMN identity information, after being disconnected from the first device, the second device does not need to detect the foregoing information broadcast by the network device, and can quickly access the network device by using the first information, so that the second device can switch from the relay link to the direct link, thereby ensuring the service continuity and improving user experience.

Optionally, in an implementation, the second device is not synchronized with the network device, the first information further includes time and frequency synchronization information; or the first information further includes time and frequency synchronization information, and at least one of the following information:

TA information, a preamble sequence number used for random access, TDD system information or FDD system information, frame timing, and PLMN identity information.

In the embodiments of the present invention, because the first information includes the time and frequency synchronization information, and may further include the at least one of the TA information, the preamble sequence number used for random access, the TDD system information or the FDD system information, the frame timing, the PLMN identity information, and the like, after being disconnected from the first device, the second device does not need to detect the foregoing information broadcast by the network device, and can quickly access the network device by using the first information, so that the second device can switch from the relay link to the direct link, thereby ensuring the service continuity and improving user experience.

Optionally, in an implementation, the second device is not synchronized with the network device, the first information further includes a time offset of frame timing; or the first information further includes a time offset of frame timing, and at least one of the following information:

TA information, a preamble sequence number used for random access, the preamble sequence number used for random access, TDD system information or FDD system information, the frame timing, and PLMN identity information.

Therefore, in the embodiments of the present invention, because the first information includes the time offset of the frame timing, and may further include the at least one of the TA information, the preamble sequence number used for random access, the preamble sequence number used for random access, the TDD system information or the FDD system information, the frame timing, the PLMN identity information, and the like, after being disconnected from the first device, the second device does not need to detect the foregoing information broadcast by the network device, and can quickly access the network device by using the first information, so that the second device can switch from the relay link to the direct link, thereby ensuring the service continuity and improving user experience.

Optionally, in an implementation, the first information further includes at least one of the following information: master information block (Master Information Block, MIB) information and system information block type 1 (System Information Block 1, SIB1) information.

Because the first information includes the information such as the MIB and the SIB1, after being disconnected from the first device, the second device does not need to detect the information such as the MIB and the SIB1 that are broadcast by the network device, and can directly and quickly access the network device by using the various kinds of system information included in the first information, so that the second device switches from the relay link to the direct link, thereby ensuring the service continuity and improving user experience.

Optionally, in an implementation, the first information further includes access control information, and the access control information is used by the second device to determine to access the network device.

Because the first information includes the access control information, when accessing a network (including accessing the network device by using the first device and directly accessing the network device), the second device does not need to perform access control detection, and directly accesses the network device by using the access control information included in the first information, thereby simplifying an access process, ensuring the service continuity, and improving user experience.

Optionally, in an implementation, the sending, by a first device, first information to a second device includes: periodically sending, by the first device, the first information to the second device.

Further, in an implementation, the periodically sending, by the first device, the first information to the second device includes: sending, by the first device, the first information to the second device based on a preset period.

Further, in an implementation, the periodically sending, by the first device, the first information to the second device includes: sending, by the first device, the first information to the second device based on a discontinuous reception (Discontinuous Reception, DRX) period of the first device or the second device.

In the embodiments of the present invention, because the first device periodically sends the first information, the second device does not need to continuously monitor and receive the first information, and the second device may periodically receive the first information, so that the second device and the first device may be in a standby or non-working state in a gap between two periods, thereby saving resources and reducing power consumption.

Optionally, in an implementation, the sending, by a first device, first information to a second device includes: sending, by the first device, the first information to the second device in a pairing process in which the first device establishes a connection to the second device.

Therefore, in the embodiments of the present invention, the first device sends the first information to the second device in the pairing process in which the first device establishes a connection to the second device, so that after being disconnected from the first device, the second device can quickly access the network device based on the received first information, and the second device can switch from the relay link to the direct link, thereby ensuring the service continuity.

Optionally, in an implementation, the sending, by a first device, first information to a second device includes: sending, by the first device, the first information to the second device when the first device performs cell handover.

Therefore, in the embodiments of the present invention, the first device sends the first information to the second device after the first device performs cell handover, so that after being disconnected from the first device, the second device can quickly access a network device in a new cell based on the received first information, and the second device can switch from the relay link to the direct link, thereby ensuring the service continuity.

Optionally, in an implementation, the sending, by a first device, first information to a second device includes: sending, by the first device, the first information to the second device when system information of the cell in which the first device is located changes.

Therefore, in the embodiments of the present invention, the first device sends the first information to the second device after cell information of the first device changes, so that after being disconnected from the first device, the second device can quickly access the network device based on the received first information, and the second device can switch from the relay link to the direct link, thereby ensuring the service continuity.

Alternatively, in an implementation, before the sending, by a first device, first information to a second device, the method further includes: receiving, by the first device, second information sent by the second device, where the second information is used to request to obtain the first information; and the sending, by a first device, first information to a second device includes: sending, by the first device, the first information to the second device after receiving the second information.

Therefore, in the embodiments of the present invention, the first device sends the first information to the second device after the first device receives a request of the second device, so that after being disconnected from the first device, the second device can quickly access the network device based on the received first information, and the second device can switch from the relay link to the direct link, thereby ensuring the service continuity.

Alternatively, in an implementation, before the sending, by a first device, first information to a second device, the method further includes: measuring, by the first device, a power of a signal of the second device, where the sending, by a first device, first information to a second device includes: sending, by the first device, the first information to the second device when the power of the signal of the second device that is measured by the first device is less than a first power threshold.

In the embodiments of the present invention, when the first device detects that the power of the signal of the second device is less than the first power threshold, it indicates that quality of communication between the first device and the second device is relatively poor. Therefore, the first device sends the first information to the second device, so that after being disconnected from the first device, the second device can quickly access the network device based on the received first information, and the second device can switch from the relay link to the direct link, thereby ensuring the service continuity.

Alternatively, in an implementation, before the sending, by a first device, first information to a second device, the method further includes: receiving, by the first device, third information sent by the second device, where the third information is used to indicate a power of a signal of the first device that is measured by the second device, and the sending, by a first device, first information to a second device includes: sending, by the first device, the first information to the second device when the power of the transmission signal of the first device that is measured by the second device is less than a second power threshold; or the third information is used to indicate that a power of a signal of the first device that is measured by the second device is less than the second power threshold, and the sending, by a first device, first information to a second device includes: sending, by the first device, the first information to the second device after receiving the third information.

In the embodiments of the present invention, when the second device detects that the power of the signal of the first device is less than the second power threshold, it indicates that quality of communication between the first device and the second device is relatively poor. Therefore, the first device sends the first information to the second device, so that after being disconnected from the first device, the second device can quickly access the network device based on the received first information, and the second device can switch from the relay link to the direct link, thereby ensuring the service continuity.

Alternatively, in an implementation, the sending, by a first device, first information to a second device includes: sending, by the first device, the first information to the second device when the first device does not receive, within a preset time period, fourth information sent by the second device, where the fourth information is used by the second device to keep a connection to the first device.

Specifically, after establishing the connection to the first device, the second device sends a keep alive message, and after receiving the keep alive message, the first device returns a keep alive acknowledgement message (keep alive ACK message), to keep the connection between the first device and the second device.

If the first device does not receive, within a time period (a preset time period), the keep alive message sent by the second device, it indicates that the second device probably leaves the first device, and in this case, the first device sends the first information to the second device. Specifically, when sending the first message, the first device may use a power higher than that used to send the keep alive acknowledgement message or a modulation and coding scheme level (Modulation and Coding Scheme level) lower than that used to send the keep alive acknowledgement message, so that the second device can receive the first information. Therefore, after being disconnected from the first device, the second device can quickly access the network device based on the received first information, and the second device can switch from the relay link to the direct link, thereby ensuring the service continuity.

Alternatively, in an implementation, the sending, by a first device, first information to a second device includes: sending, by the first device, a paging message to the second device, where the paging message includes the first information.

In the embodiments of the present invention, the first information is added to the paging message, so that after being disconnected from the first device, the second device can quickly access the network device based on the received first information, and the second device can switch from the relay link to the direct link, thereby ensuring the service continuity.

According to a second aspect, an information transmission method is provided, including: receiving, by a second device, first information sent by a first device, where the first information includes a cell identity of a first cell, the first cell is a serving cell of the first device, the second device accesses the first cell by using the first device, and the first information is used by the second device to determine the cell identity of the first cell.

Therefore, in the embodiments of the present invention, the second device receives the first information sent by the first device, so that the second device can quickly perform cell measurement based on the first information, and quickly switch from a relay link to a direct link, thereby ensuring continuity of a service on the second device and improving user experience.

It should be understood that the second aspect corresponds to the first aspect, an execution body of the first aspect is the first device, and an execution body of the second aspect may be the second device. For corresponding features and corresponding beneficial effects of the method on the second device side, refer to the corresponding descriptions on the first device side in the first aspect. Therefore, for brevity, detailed descriptions are omitted appropriately.

Optionally, in an implementation, the second device accesses the first cell based on the first information.

Optionally, in an implementation, the second device is synchronized with the network device, and the first information further includes at least one of the following information: uplink signal timing advance TA information, time division duplex TDD system information or frequency division duplex FDD system information, a preamble sequence number used for random access, and public land mobile network PLMN identity information.

Alternatively, in an implementation, the second device is not synchronized with the network device, the first information further includes time and frequency synchronization information; or the first information further includes time and frequency synchronization information, and at least one of the following information: TA information, a preamble sequence number used for random access, TDD system information or FDD system information, frame timing, and PLMN identity information.

Alternatively, in an implementation, the second device is not synchronized with the network device, the first information further includes a time offset of frame timing; or the first information further includes a time offset of frame timing, and at least one of the following information: TA information, a preamble sequence number used for random access, the preamble sequence number used for random access, TDD system information or FDD system information, the frame timing, and PLMN identity information.

Optionally, in an implementation, the first information further includes at least one of the following information: master information block MIB information and system information block type 1 SIB1 information.

Optionally, in an implementation, the first information further includes access control information, and the access control information is used by the second device to determine, based on the access control information, that the second device can access the network device; and before the accessing, by the second device, the network device based on the first information, the method further includes: determining, by the second device based on the access control information, that the second device can access the network device.

Optionally, in an implementation, the receiving, by a second device, first information sent by a first device includes: periodically receiving, by the second device, the first information sent by the first device.

Optionally, in an implementation, the periodically receiving, by the second device, the first information sent by the first device includes: receiving, by the second device based on a preset period, the first information sent by the first device.

Optionally, in an implementation, the periodically receiving, by the second device, the first information sent by the first device includes: receiving, by the second device based on a discontinuous reception DRX period of the first device or the second device, the first information sent by the first device.

Optionally, in an implementation, the receiving, by a second device, first information sent by a first device includes: receiving, by the second device in any one of the following cases, the first information sent by the first device: when the first device establishes a connection to the second device for pairing; when the first device performs cell handover; and when system information of the cell in which the first device is located changes.

Alternatively, in an implementation, before the receiving, by a second device, first information sent by a first device, the method further includes: sending, by the second device, second information to the first device, where the second information is used to request to obtain the first information; and the receiving, by a second device, first information sent by a first device includes: receiving, by the second device, the first information that is sent by the first device after the first device receives the second information.

Alternatively, in an implementation, the receiving, by a second device, first information sent by a first device includes: receiving, by the second device, the first information that is sent by the first device when the first device detects that a power of a signal of the second device is less than a first power threshold.

Alternatively, in an implementation, before the receiving, by a second device, first information sent by a first device, the method further includes: sending, by the second device, third information to the first device, where the third information is used to indicate a power of a signal of the first device that is measured by the second device, and the receiving, by a second device, first information sent by a first device includes: receiving, by the second device, the first information that is sent by the first device when the power of the transmission signal of the first device that is measured by the second device is less than a second power threshold; or the third indication information is used to indicate that a power of a signal of the first device that is measured by the second device is less than the second power threshold, and the receiving, by a second device, first information sent by a first device includes: receiving, by the second device, the first information that is sent by the first device after the first device receives the third information.

Alternatively, in an implementation, the receiving, by a second device, first information sent by a first device includes: receiving, by the second device, the first information that is sent by the first device when the first device does not receive, within a preset time period, a fourth message sent by the second device, where the fourth information is used by the second device to keep a connection to the first device.

Alternatively, in an implementation, the receiving, by a second device, first information sent by a first device includes: receiving, by the second device, a paging message sent by the first device, where the paging message includes the first information.

According to a third aspect, a first terminal is provided, and is configured to perform the method in the first aspect or any possible implementation of the first aspect. Specifically, the first device includes units configured to perform the method.

It should be understood that the third aspect corresponds to the first aspect, and for functions and corresponding beneficial effects of the units in the first device, refer to the corresponding descriptions of the method in the first aspect or any possible implementation of the first aspect. Therefore, for brevity, detailed descriptions are omitted appropriately.

According to a fourth aspect, a second device is provided, and is configured to perform the method in the second aspect or any possible implementation of the second aspect. Specifically, the second device includes units configured to perform the method.

It should be understood that the fourth aspect corresponds to the second aspect, and for functions and corresponding beneficial effects of the units in the second device, refer to the corresponding descriptions of the method in the second aspect or any possible implementation of the second aspect. Therefore, for brevity, detailed descriptions are omitted appropriately.

According to a fifth aspect, a first device is provided. The first device includes a processor and a memory, the memory is configured to store a computer program, and the processor is configured to execute the computer program stored in the memory, to perform the method in the first aspect or any possible implementation of the first aspect.

It should be understood that the fifth aspect corresponds to the first aspect, and for functions and corresponding beneficial effects of the processor of the first device, refer to the corresponding descriptions of the method in the first aspect or any possible implementation of the first aspect. Therefore, for brevity, detailed descriptions are omitted appropriately.

According to a sixth aspect, a second device is provided. The second device includes a processor and a memory, the memory is configured to store a computer program, and the processor is configured to execute the computer program stored in the memory, to perform the method in the second aspect or any possible implementation of the second aspect.

It should be understood that the sixth aspect corresponds to the second aspect, and for functions and corresponding beneficial effects of the units in the second device, refer to the corresponding descriptions of the method in the second aspect or any possible implementation of the second aspect. Therefore, for brevity, detailed descriptions are omitted appropriately.

According to a seventh aspect, a computer readable medium is provided, and is configured to store a computer program. The computer program includes an instruction used to perform the method in the first aspect or any possible implementation of the first aspect.

It should be understood that the seventh aspect corresponds to the first aspect, and for the method capable of being implemented by the instruction stored in the computer storage medium and corresponding beneficial effects, refer to the corresponding descriptions of the method in the first aspect or any possible implementation of the first aspect. Therefore, for brevity, detailed descriptions are omitted appropriately.

According to an eighth aspect, a computer readable medium is provided, and is configured to store a computer program. The computer program includes an instruction used to perform the method in the second aspect or any possible implementation of the second aspect.

It should be understood that the eighth aspect corresponds to the second aspect, and for the method capable of being implemented by the instruction stored in the computer storage medium and corresponding beneficial effects, refer to the corresponding descriptions of the method in the second aspect or any possible implementation of the second aspect. Therefore, for brevity, detailed descriptions are omitted appropriately.

### BRIEF DESCRIPTION OF THE DRAWINGS

FIG. 1 is a diagram of a scenario of a communications system to which embodiments of the present invention can be applied;

FIG. 2 is a flowchart of an information transmission method according to an embodiment of the present invention;

FIG. 3 is a flowchart of an information transmission method according to another embodiment of the present invention;

FIG. 4 is a flowchart of an information transmission method according to another embodiment of the present invention;

FIG. 5 is a flowchart of an information transmission method according to another embodiment of the present invention;

FIG. 6 is a flowchart of an information transmission method according to another embodiment of the present invention;

FIG. 7 is a flowchart of an information transmission method according to another embodiment of the present invention;

FIG. 8 is a flowchart of an information transmission method according to another embodiment of the present invention;

FIG. 9 is a flowchart of an information transmission method according to another embodiment of the present invention;

FIG. 10 is a flowchart of an information transmission method according to another embodiment of the present invention;

FIG. 11 is a flowchart of an information transmission method according to another embodiment of the present invention;

FIG. 12 is a flowchart of an information transmission method according to another embodiment of the present invention;

FIG. 13 is a schematic block diagram of a first device according to an embodiment of the present invention;

FIG. 14 is a schematic block diagram of a second device according to an embodiment of the present invention;

FIG. 15 is a schematic block diagram of a first device according to another embodiment of the present invention; and

FIG. 16 is a schematic block diagram of a second device according to another embodiment of the present invention.

### DETAILED DESCRIPTION OF ILLUSTRATIVE EMBODIMENTS

The following clearly and completely describes the technical solutions in the embodiments of the present invention with reference to the accompanying drawings in the embodiments of the present invention.

It should be understood that, the technical solutions of the embodiments of the present invention may be applied to various communications systems, for example, a Global System for Mobile Communications (Global System for Mobile Communications, GSM) system, a Code Division Multiple Access (Code Division Multiple Access, CDMA) system, a Wideband Code Division Multiple Access (Wideband Code Division Multiple Access, WCDMA) system, a general packet radio service (General Packet Radio Service, GPRS), a Long Term Evolution (Long Term Evolution, LTE) system, an LTE frequency division duplex (Frequency Division Duplex, FDD) system, an LTE time division duplex (Time Division Duplex, TDD) system, Universal Mobile Telecommunications System (Universal Mobile Telecommunications System, UMTS), and a Worldwide Interoperability for Microwave Access (Worldwide Interoperability for Microwave Access, WiMAX) communications system. The embodiments of the present invention are not limited thereto.

It should be further understood that a network device in the embodiments of the present invention may be a base transceiver station (Base Transceiver Station, BTS) in a GSM system or a Code Division Multiple Access (Code Division Multiple Access, CDMA) system, or may be a Node B (NodeB, NB) in a WCDMA system, or may be an evolved Node B (Evolved Node B, eNB or eNodeB) in an LTE system, or may be a radio controller in a cloud radio access network (Cloud Radio Access Network, CRAN), or the network device may be a relay station, an access point, an in-vehicle device, a wearable device, a network side device in a future 5G network, a network device in a future evolved public land mobile network (Public Land Mobile Network, PLMN), or the like.

In the embodiments of the present invention, a first device accesses the network device in a wireless manner. The first device may be a terminal device, for example, may be an access terminal, user equipment (User Equipment, UE), a subscriber unit, a subscriber station, a mobile station, a mobile console, a remote station, a remote terminal, a mobile device, a customer terminal, a terminal, a wireless communications device, a user agent, or a user apparatus. The access terminal may be a cellular phone, a cordless phone, a Session Initiation Protocol (Session Initiation Protocol, SIP) phone, a wireless local loop (Wireless Local Loop, WLL) station, a personal digital assistant (Personal Digital Assistant, PDA), a handheld device having a wireless communication function, a computing device, another processing device connected to a wireless modem, an in-vehicle device, a wearable device, a terminal device in a future 5G network, a terminal device in a future evolved public land mobile network (Public Land Mobile Network, PLMN), or the like.

In the embodiments of the present invention, a second device may access the first device in a wireless manner. For example, the first device may be connected to the second device in a short range communication manner such as Bluetooth, wireless fidelity (Wireless Fidelity, WiFi), infrared, unlicensed spectrum access, or device to device (Device to Device, D2D) communication, and the embodiments of the present invention are not limited thereto. The second device accesses the network device by using the first device. The second device may alternatively access the network device directly. The second device may also be a terminal device, for example, an access terminal, user equipment (User Equipment, UE), a subscriber unit, a subscriber station, a mobile station, a mobile console, a remote station, a remote terminal, a mobile device, a customer terminal, a terminal, a wireless communications device, a user agent, or a user apparatus. The access terminal may be a cellular phone, a cordless phone, a Session Initiation Protocol (Session Initiation Protocol, SIP) phone, a wireless local loop (Wireless Local Loop, WLL) station, a personal digital assistant (Personal Digital Assistant, PDA), a handheld device having a wireless communication function, a computing device, another processing device connected to a wireless modem, an in-vehicle device, a wearable device, a terminal device in a future 5G network, a terminal device in a future evolved public land mobile network (Public Land Mobile Network, PLMN), or the like.

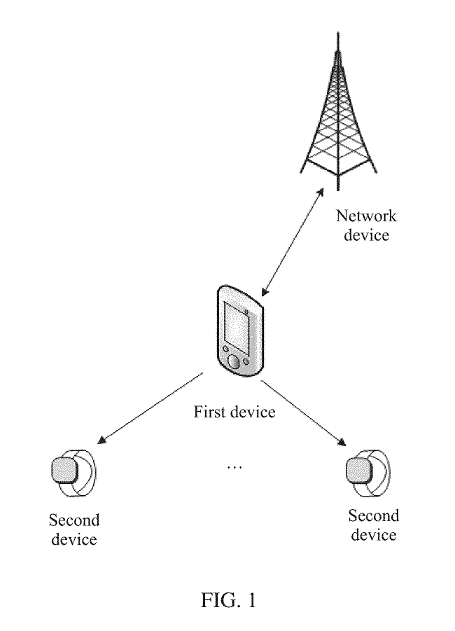

FIG. 1 is a diagram of a scenario of a communications system to which the embodiments of the present invention can be applied. In FIG. 1, the communications system includes a network device, a first device, and a second device. The second device is connected to the network device by using the first device, and the first device is connected to the second device in a short range communication manner such as Bluetooth, WiFi, D2D, infrared, or unlicensed spectrum access. The first device may directly access the network device, and may be used as a relay node to assist the second device in connecting to a network. The second device may directly access the network device without using the first device.

For example, the first device may be a smartphone, and the second device may be various intelligent wearable devices carried by a user. When these wearable devices need to connect to a network to transmit data or establish a voice call service, these wearable devices may connect to the network through relaying by using the smartphone, and do not need to directly connect to the network. Because the wearable device is connected to the smartphone through short range communication, power consumption of the wearable device can be reduced, and a transmission rate of the wearable device can be increased. Each first device may connect to a plurality of second devices, and connect the second devices to the network through relaying.

As shown in FIG. 1, each second device can connect to a network in two manners. In one manner, the second device connects to the network through relaying by using the first device (for example, a mobile phone); in the other manner, the second device directly connects to the network by using a direct link.

When the second device is connected to the network by using the first device, and when a connection between the second device and the first device is abnormal, or a connection signal is weak, or the second device is disconnected from the first device, a service (for example, a voice service) on the second device is interrupted, affecting user experience.

In view of this problem, the embodiments of the present invention subtly propose a solution in which the second device switches from a current relay link to a direct link, to ensure continuity of the service on the second device, for example, continuity of the voice service. Specifically, in the embodiments of the present invention, the first device sends first information to the second device, so that the second device accesses the network device based on the first information, and the second device can switch from the relay link to the direct link.

For convenience of understanding and description, by way of example rather than limitation, an execution process and execution actions of the information transmission method and the device of the present invention in the communications system are described below.

It should be understood that in the embodiments of the present invention, that the second device connects to the network device may also be described as that the second device accesses the network device or the second device accesses a serving cell of the first device, namely a first cell. The first cell may also be referred to as a cell in which the network device is located. The embodiments of the present invention are not limited thereto.

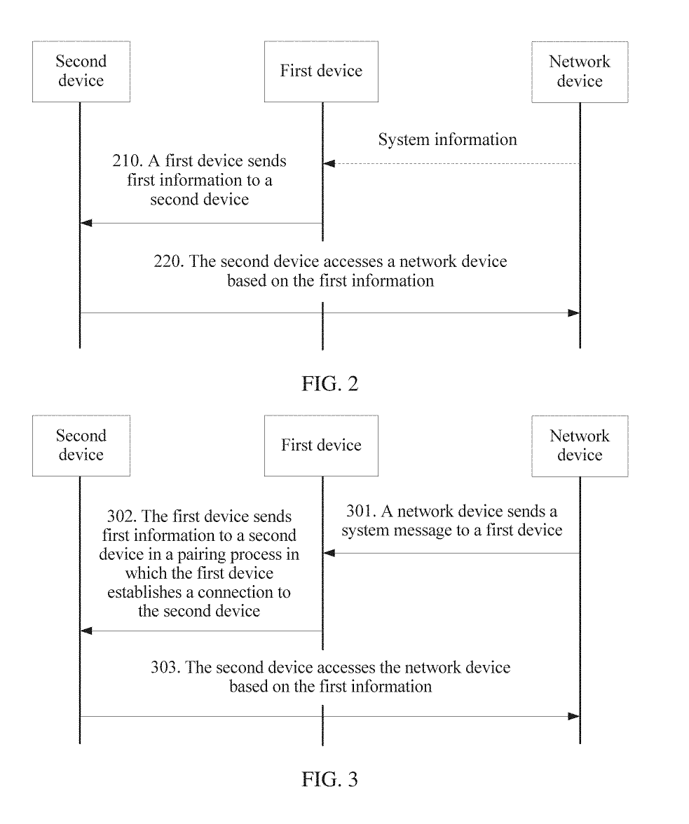

FIG. 2 is a schematic flowchart of an information transmission method according to an embodiment of the present invention. The method shown in FIG. 2 may be applied to the foregoing various communications systems. A communications system to which this embodiment of the present invention can be applied includes a network device, a first device, and a second device. The method 200 shown in FIG. 2 includes the following steps:

210. The first device sends first information to the second device.

The first information includes a cell identity of a first cell, the first cell is a serving cell of the first device, the second device accesses the first cell by using the first device, and the first information is used by the second device to determine the cell identity of the first cell.

In other words, the first device is connected to the network device, the second device is connected to the network device by using the first device, the first information includes identity information of the serving cell of the first device, namely the first cell, and the first information is used by the second device to determine the cell identity of the serving cell, to access the first cell.

Specifically, in this embodiment of the present invention, after the second device connects to the first device, the second device still needs to measure a direct link, so that the second device can quickly switch to the direct link after leaving coverage of the first device, thereby ensuring service continuity.

Therefore, in this embodiment of the present invention, the first device sends the first information to the second device, so that the second device can quickly perform cell measurement based on the first information, and quickly switch from a relay link to the direct link, thereby ensuring continuity of a service on the second device and improving user experience.

It should be understood that before the first device sends the first information, the first device receives a system message sent by the network device. For example, the first device receives the system message broadcast by the network device, generates the first information based on the system message, and sends the first information to the second device.

Specifically, for a manner of sending, by the network device, the system message and specific content of the system message, refer to regulations in an existing standard, and details are not described herein.

It should be noted that in this embodiment of the present invention, the first information may be the system message sent by the network device, or may include the system message, or the first information may be a subset of the system message. This embodiment of the present invention is not limited thereto. Therefore, the first information in this embodiment of the present invention may also be referred to as system information, a system message, system-related information, or the like, and this embodiment of the present invention is not limited thereto.

In this embodiment of the present invention, the first device may send the first information in a broadcast manner, or may send the first information in a device to device (Device to Device, D2D) communication manner, or may send the first information in another short range communication manner. This is not limited in this embodiment of the present invention.

Because the first information includes the identity information of the serving cell of the first device, namely the first cell, after being disconnected from the first device, the second device can quickly access the network device by using the identity information of the serving cell, so that the second device can switch from the relay link to the direct link, thereby ensuring the service continuity and improving user experience.

It should be understood that in this embodiment of the present invention, for different scenarios, content of the first information may be different, and the following gives a detailed description by way of example.

Optionally, in another example, in a scenario in which the second device is synchronized with the network device, the first information may further include at least one of the following information: uplink signal timing advance TA information, time division duplex TDD system information or frequency division duplex FDD system information, a preamble sequence number used for random access, and public land mobile network PLMN identity information.

The second device can quickly access the network device in a contention-free manner by using the preamble sequence number used for random access.

Specifically, when the first information includes the preamble sequence number, before the first device sends the first information, the first device needs to apply for a preamble sequence in a contention-free group from the network device, and then send a preamble sequence number of the preamble sequence to the second device by using the first information.

The second device directly sends an access signal to the network device by using the uplink signal timing advance TA information, and the network device does not need to indicate the uplink signal timing advance TA information, so that the second device can quickly access the network device.

Specifically, because the first device is relatively close to the second device, the second device may directly send the access signal to the network device by using the uplink signal timing advance TA information of the first device, and the network device does not need to indicate the uplink signal timing advance TA information, so that the second device can quickly access the network device.

The second device recognizes a type of the network device by using the time division duplex TDD system information or the frequency division duplex FDD system information and/or the public land mobile network PLMN identity information, and does not need to re-read system information, so that the second device quickly accesses the network device.

It should be understood that in this embodiment of the present invention, the first device is synchronized with the network device, and the second device is synchronized with the first device. Therefore, it may be considered that the second device is synchronized with the network device.

In this embodiment of the present invention, because the first information includes the at least one of the uplink signal timing advance TA information, the time division duplex TDD system information or the frequency division duplex FDD system information, the preamble sequence number used for random access, and the public land mobile network PLMN identity information, after being disconnected from the first device, the second device does not need to detect the foregoing information broadcast by the network device, and can quickly access the network device by using the first information, so that the second device can switch from the relay link to the direct link, thereby ensuring the service continuity and improving user experience.

Alternatively, in another embodiment, in a scenario in which the second device is not synchronized with the network device, the first information further includes time and frequency synchronization information.

The time and frequency synchronization information is used to synchronize the second device with the network device.

Optionally, when the first information includes the time and frequency synchronization information, the first information may further include at least one of the following information: TA information, a preamble sequence number used for random access, TDD system information or FDD system information, frame timing, and PLMN identity information.

In this embodiment of the present invention, because the first information includes the time and frequency synchronization information, and may further include the at least one of the TA information, the preamble sequence number used for random access, the TDD system information or the FDD system information, the frame timing, the PLMN identity information, and the like, after being disconnected from the first device, the second device does not need to detect the foregoing information broadcast by the network device, and can quickly access the network device by using the first information, so that the second device can switch from the relay link to the direct link, thereby ensuring the service continuity and improving user experience.

Alternatively, in another embodiment, in a scenario in which the second device is not synchronized with the network device, the first information further includes a time offset of frame timing.

The time offset of the frame timing is used to synchronize the second device with the network device.

Optionally, when the first information includes the time offset of the frame timing, the first information may further include at least one of the following information: TA information, a preamble sequence number used for random access, the preamble sequence number used for random access, TDD system information or FDD system information, the frame timing, and PLMN identity information.

Therefore, in this embodiment of the present invention, because the first information includes the time offset of the frame timing, and may further include the at least one of the TA information, the preamble sequence number used for random access, the preamble sequence number used for random access, the TDD system information or the FDD system information, the frame timing, the PLMN identity information, and the like, after being disconnected from the first device, the second device does not need to detect the foregoing information broadcast by the network device, and can quickly access the network device by using the first information, so that the second device can switch from the relay link to the direct link, thereby ensuring the service continuity and improving user experience.

It should be understood that in the foregoing scenarios, the first information in this embodiment of the present invention may further include system information such as master information block MIB information and system information block type 1 SIB1 information, and this embodiment of the present invention is not limited thereto.

Because the first information includes the information such as the MIB and the SIB1, after being disconnected from the first device, the second device does not need to detect the information such as the MIB and the SIB1 that are broadcast by the network device, and can directly and quickly access the network device by using the various kinds of system information included in the first information, so that the second device switches from the relay link to the direct link, thereby ensuring the service continuity and improving user experience.

It should be understood that in the foregoing various embodiments, the first information may further include access control information, and the access control information is used by the second device to determine to access the network device.

Because the first information includes the access control information, when accessing a network (including accessing the network device by using the first device and directly accessing the network device), the second device does not need to perform access control detection, and directly accesses the network device by using the access control information included in the first information, thereby simplifying an access process, ensuring the service continuity, and improving user experience.

220. The second device accesses the network device based on the first information.

For example, after being disconnected from the first device, the second device directly accesses the network device based on the first information.

Therefore, in this embodiment of the present invention, the first device sends the first information to the second device, so that after being disconnected from the first device, the second device can quickly access the network device based on the received first information, and the second device can switch from the relay link to the direct link, thereby ensuring the service continuity.

Specific content of the first information is described above. In this embodiment of the present invention, there are a plurality of possible triggering conditions for sending the first information. The following describes the triggering conditions for sending the first information in the present invention with reference to specific examples.

Optionally, in 210, the first device periodically sends the first information to the second device.

For example, the first device sends the first information to the second device based on a preset period. Correspondingly, the second device may receive the first information based on the preset period.

For another example, the first device sends the first information to the second device based on a discontinuous reception DRX period of the first device. Correspondingly, the second device may receive the first information based on the DRX of the first device.

For another example, the first device sends the first information to the second device based on a DRX period of the second device. Correspondingly, the second device receives the first information based on the DRX period of the second device. This case is applicable to a scenario in which UE is connected to a small quantity of WDs, and is not applicable to a scenario in which UE is connected to a plurality of WDs. If the UE is connected to a plurality of WDs, the UE needs to perform sending based on a DRX period of each WD, resulting in frequent sending. Consequently, it is not beneficial for the UE to reduce power consumption or resource consumption.

Therefore, in this embodiment of the present invention, because the first device periodically sends the first information, the second device does not need to continuously monitor and receive the first information, and the second device may periodically receive the first information, so that the second device and the first device may be in a standby or non-working state in a gap between two periods, thereby saving resources and reducing power consumption.

Alternatively, in 210, the first device may send the first information when a triggering condition is satisfied.

For example, as shown in FIG. 3, in another embodiment of the present invention, the first device sends the first information to the second device in a pairing process in which the first device establishes a connection to the second device. A method shown in FIG. 3 includes the following steps.

301. The network device sends a system message to the first device.

For example, the first device may receive the system message broadcast by the network device.

Specifically, for specific content of the system message, refer to descriptions in the existing standard, and details are not described herein.

302. The first device sends the first information to the second device in a pairing process in which the first device establishes a connection to the second device.

It should be understood that step 302 corresponds to step 210, and for descriptions of the first information, refer to the descriptions of step 210. To avoid repetition, details are not described herein again.

303. The second device accesses the network device based on the first information.

It should be understood that step 303 is similar to step 220 in FIG. 2, and to avoid repetition, details are not described herein again.

Therefore, in this embodiment of the present invention, the first device sends the first information to the second device in the pairing process in which the first device establishes a connection to the second device, so that after being disconnected from the first device, the second device can quickly access the network device based on the received first information, and the second device can switch from the relay link to the direct link, thereby ensuring the service continuity.

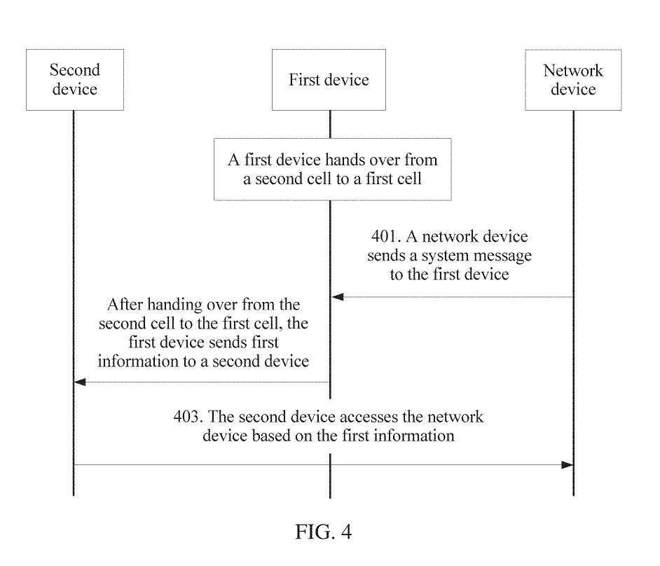

Alternatively, as shown in FIG. 4, in another embodiment of the present invention, the first device sends the first information to the second device when a cell of the first device changes. A method shown in FIG. 4 includes the following steps.

401. The network device sends a system message to the first device.

It should be understood that the network device is a network device in a new cell to which the first device hands over.

For example, after the first device hands over from a second cell to the first cell, the network device in the first cell sends the system message to the first device.

For example, the first device may receive the system message broadcast by the network device in the first cell.

Specifically, for specific content of the system message, refer to descriptions in the existing standard, and details are not described herein.

402. The first device sends the first information to the second device after handing over from a second cell to the first cell.

It should be understood that step 402 corresponds to step 210, and for descriptions of the first information, refer to the descriptions of step 210. To avoid repetition, details are not described herein again.

403. The second device accesses the network device based on the first information.

It should be understood that step 403 is similar to step 220 in FIG. 2, and to avoid repetition, details are not described herein again.

Therefore, in this embodiment of the present invention, the first device sends the first information to the second device after the first device performs cell handover, so that after being disconnected from the first device, the second device can quickly access the network device in the new cell based on the received first information, and the second device can switch from the relay link to the direct link, thereby ensuring the service continuity.

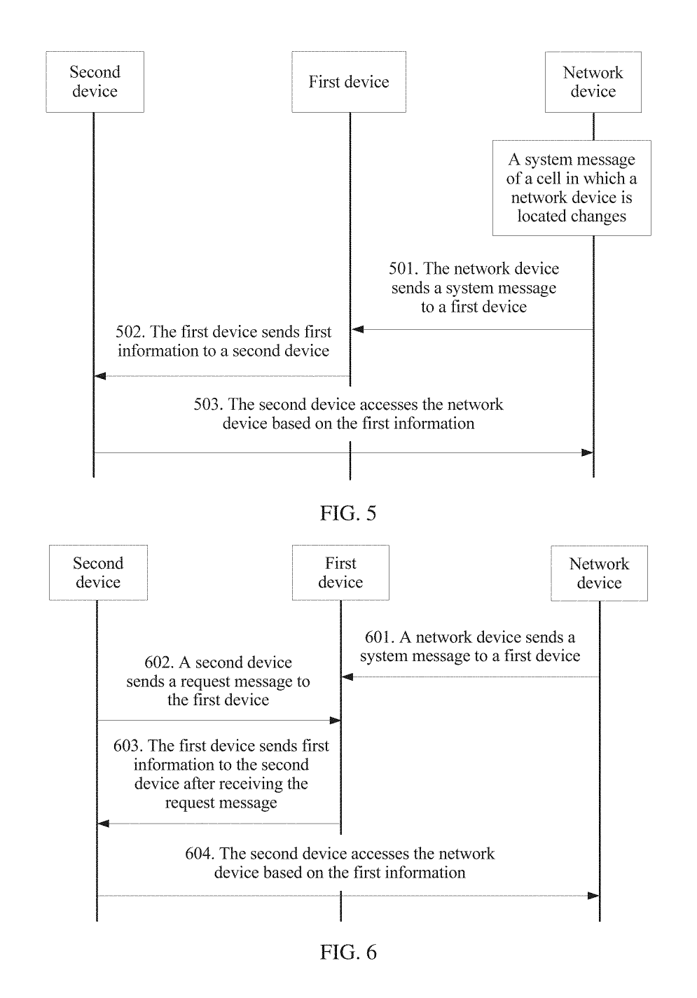

Alternatively, as shown in FIG. 5, in another embodiment of the present invention, the first device sends the first information to the second device when system information of the cell in which the first device is located changes. Specifically, a method shown in FIG. 5 includes the following steps.

501. The network device sends a system message to the first device.

Specifically, the network device sends the system message to the first device after the system message of the cell in which the network device is located changes.

For example, the first device may receive the changed system message broadcast by the network device.

Specifically, for specific content of the system message, refer to descriptions in the existing standard, and details are not described herein.

502. The first device sends the first information to the second device.

It should be understood that step 502 corresponds to step 210, and for descriptions of the first information, refer to the descriptions of step 210. To avoid repetition, details are not described herein again.

503. The second device accesses the network device based on the first information.

It should be understood that step 503 is similar to step 220 in FIG. 2, and to avoid repetition, details are not described herein again.

Therefore, in this embodiment of the present invention, the first device sends the first information to the second device after cell information of the first device changes, so that after being disconnected from the first device, the second device can quickly access the network device based on the received first information, and the second device can switch from the relay link to the direct link, thereby ensuring the service continuity.

Alternatively, as shown in FIG. 6, in another embodiment of the present invention, the first device sends the first information to the second device after receiving second information that is used to request the first message and that is sent by the second device. Specifically, a method shown in FIG. 6 includes the following steps.

601. The network device sends a system message to the first device.

For example, the first device may receive the system message broadcast by the network device.

Specifically, for specific content of the system message, refer to descriptions in the existing standard, and details are not described herein.

602. The second device sends second information to the first device.

The second information is used to request to obtain the first information.

603. The first device sends the first information to the second device after receiving the second information.

It should be understood that step 603 corresponds to step 210, and for descriptions of the first information, refer to the descriptions of step 210. To avoid repetition, details are not described herein again.

604. The second device accesses the network device based on the first information.

It should be understood that step 604 is similar to step 220 in FIG. 2, and to avoid repetition, details are not described herein again.

Therefore, in this embodiment of the present invention, the first device sends the first information to the second device after receiving a request of the second device, so that after being disconnected from the first device, the second device can quickly access the network device based on the received first information, and the second device can switch from the relay link to the direct link, thereby ensuring the service continuity.

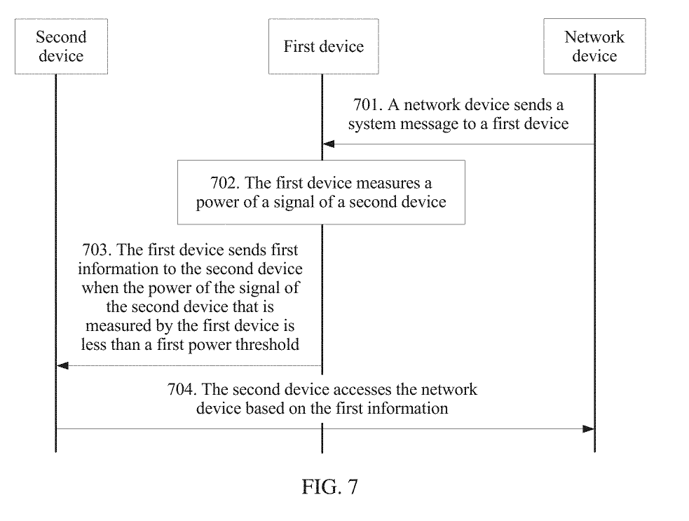

Alternatively, as shown in FIG. 7, in another embodiment of the present invention, the first device sends the first information to the second device when a power of a signal of the second device that is measured by the first device is less than a first power threshold. Specifically, a method shown in FIG. 7 includes the following steps.

701. The network device sends a system message to the first device.

For example, the first device may receive the system message broadcast by the network device.

Specifically, for specific content of the system message, refer to descriptions in the existing standard, and details are not described herein.

702. The first device measures a power of a signal of the second device.

703. The first device sends the first information to the second device when the power of the signal of the second device that is measured by the first device is less than a first power threshold.

It should be understood that in this embodiment of the present invention, the first power threshold may be a preset value. Step 703 corresponds to step 210, and for descriptions of the first information, refer to the descriptions of step 210. To avoid repetition, details are not described herein again.

704. The second device accesses the network device based on the first information.

It should be understood that step 704 is similar to step 220 in FIG. 2, and to avoid repetition, details are not described herein again.

It should be understood that during actual application, the signal power of the second device that is measured by the first device may be greater than, less than, or equal to the first power threshold. When the signal power of the second device that is measured by the first device is greater than or equal to the first power threshold, it indicates that quality of communication between the first device and the second device is relatively good, and that the first device may not need to send the first information to the second device.

In this embodiment of the present invention, when the first device detects that the power of the signal of the second device is less than the first power threshold, it indicates that the quality of the communication between the first device and the second device is relatively poor. Therefore, the first device sends the first information to the second device, so that after being disconnected from the first device, the second device can quickly access the network device based on the received first information, and the second device can switch from the relay link to the direct link, thereby ensuring the service continuity.

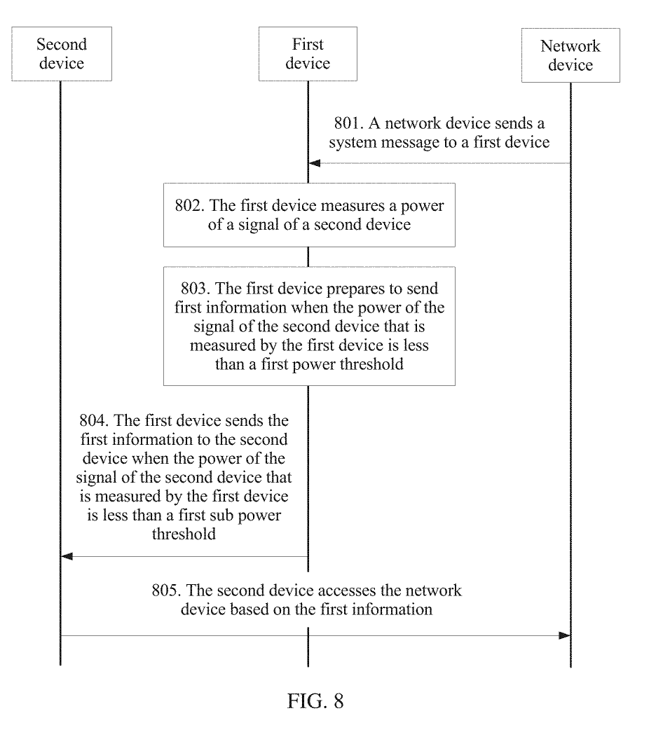

In this embodiment of the present invention, a first sub power threshold may further be set. The first sub power threshold is less than the first power threshold. The first device sends the first information to the second device when the power of the signal of the second device that is measured by the first device is less than the first sub power threshold. Specifically, a method shown in FIG. 8 includes the following steps.

801. The network device sends a system message to the first device.

For example, the first device may receive the system message broadcast by the network device.

Specifically, for specific content of the system message, refer to descriptions in the existing standard, and details are not described herein.

802. The first device measures a power of a signal of the second device.

803. The first device prepares to send the first information when the power of the signal of the second device that is measured by the first device is less than a first power threshold.

804. The first device sends the first information to the second device when the power of the signal of the second device that is measured by the first device is less than a first sub power threshold.

It should be understood that in this embodiment of the present invention, the first power threshold and the first sub power threshold may be preset values. Step 804 corresponds to step 210, and for descriptions of the first information, refer to the descriptions of step 210. To avoid repetition, details are not described herein again.

805. The second device accesses the network device based on the first information.

It should be understood that step 805 is similar to step 220 in FIG. 2, and to avoid repetition, details are not described herein again.

Compared with FIG. 7, in FIG. 8, because the first device sends the first information only when the power of the signal of the second device is less than the first sub power threshold, it can be avoided that the first device repeatedly sends the first information to the second device.

In this embodiment of the present invention, when the first device detects that the power of the signal of the second device is less than the first power threshold, it indicates that quality of communication between the first device and the second device is relatively poor. Therefore, the first device sends the first information to the second device, so that after being disconnected from the first device, the second device can quickly access the network device based on the received first information, and the second device can switch from the relay link to the direct link, thereby ensuring the service continuity.

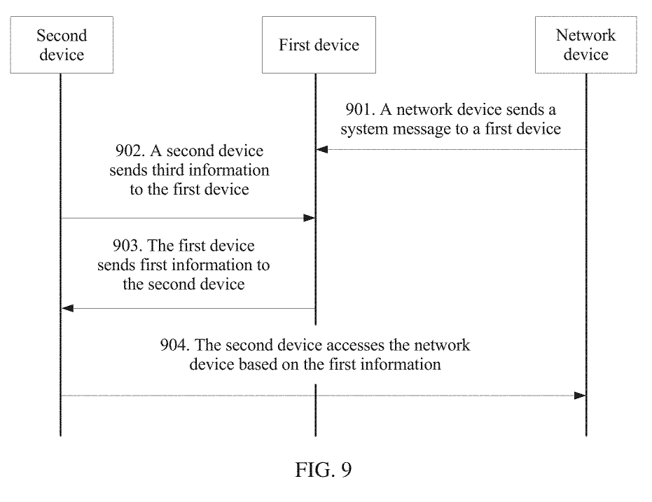

Alternatively, as shown in FIG. 9, in another embodiment of the present invention, the first device sends the first information to the second device when a power of a signal of the first device that is measured by the second device is less than a second power threshold. Specifically, a method shown in FIG. 9 includes the following steps.

901. The network device sends a system message to the first device.

For example, the first device may receive the system message broadcast by the network device.

Specifically, for specific content of the system message, refer to descriptions in the existing standard, and details are not described herein.

902. The second device sends third information to the first device.

The third information is used to indicate the power of the signal of the first device that is measured by the second device, or the third information is used to indicate that the power of the signal of the first device that is measured by the second device is less than the second power threshold.

903. The first device sends the first information to the second device.

Specifically, the first device sends the first information to the second device when the power of the signal of the first device that is measured by the second device is less than the second power threshold.

Alternatively, when the third information is used to indicate that the power of the signal of the first device that is measured by the second device is less than the second power threshold, the first device sends the first information to the second device after receiving the third information. Step 903 corresponds to step 210, and for descriptions of the first information, refer to the descriptions of step 210. To avoid repetition, details are not described herein again.

904. The second device accesses the network device based on the first information.

It should be understood that step 904 is similar to step 220 in FIG. 2, and to avoid repetition, details are not described herein again.

It should be understood that during actual application, the signal power of the first device that is measured by the second device may be greater than, less than, or equal to the second power threshold. When the signal power of the first device that is measured by the second device is greater than or equal to the second power threshold, it indicates that quality of communication between the first device and the second device is relatively good, and the first device may not need to send the first information to the second device.

In this embodiment of the present invention, when the second device detects that the power of the signal of the first device is less than the second power threshold, it indicates that the quality of the communication between the first device and the second device is relatively poor. Therefore, the first device sends the first information to the second device, so that after being disconnected from the first device, the second device can quickly access the network device based on the received first information, and the second device can switch from the relay link to the direct link, thereby ensuring the service continuity.

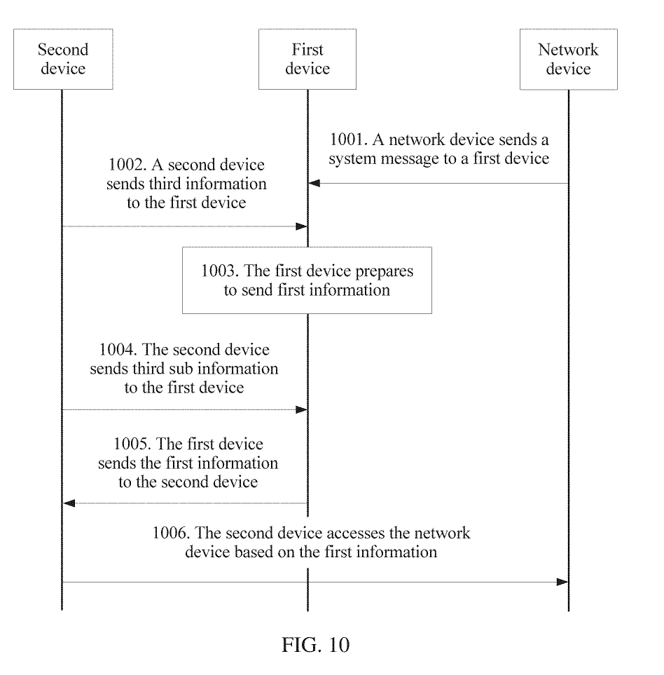

In this embodiment of the present invention, a second sub power threshold may further be set. The second sub power threshold is less than the first power threshold. When the power of the signal of the first device that is measured by the second device is less than the second sub power threshold, the first device sends the first information to the second device. Specifically, a method shown in FIG. 10 includes the following steps:

1001. The network device sends a system message to the first device.

For example, the first device may receive the system message broadcast by the network device.

Specifically, for specific content of the system message, refer to descriptions in the existing standard, and details are not described herein.

1002. The second device sends third information to the first device.

The third information is used to indicate the power of the signal of the first device that is measured by the second device, or the third information is used to indicate that the power of the signal of the first device that is measured by the second device is less than the second power threshold.

1003. The first device prepares to send the first information.

Specifically, the first device prepares to send the first information when the power of the signal of the first device that is measured by the second device is less than the second power threshold.

Alternatively, when the third information is used to indicate that the power of the signal of the first device that is measured by the second device is less than the second power threshold, the first device prepares to send the first information.

1004. The second device sends third sub information to the first device.

The third sub information is used to indicate the power of the signal of the first device that is measured by the second device, or the third sub information is used to indicate that the power of the signal of the first device that is measured by the second device is less than the second sub power threshold. Herein, the third sub information may be the third information, and this is not specifically limited in this embodiment.

1005. The first device sends the first information to the second device.

Specifically, the first device sends the first information to the second device when the power of the signal of the first device that is measured by the second device is less than the second sub power threshold.

Alternatively, when the third sub information is used to indicate that the power of the signal of the first device that is measured by the second device is less than the second sub power threshold, the first device sends the first information to the second device after receiving the third sub information. Step 1005 corresponds to step 210, and for descriptions of the first information, refer to the descriptions of step 210. To avoid repetition, details are not described herein again.

1006. The second device accesses the network device based on the first information.

It should be understood that step 1006 is similar to step 220 in FIG. 2, and to avoid repetition, details are not described herein again.

Compared with FIG. 9, in FIG. 10, because the first device sends the first information only when the power of the signal of the first device that is measured by the second device is less than the second sub power threshold, it can be avoided that the first device repeatedly sends the first information to the second device.

In this embodiment of the present invention, when the second device detects that the power of the signal of the first device is less than the second power threshold, it indicates that quality of communication between the first device and the second device is relatively poor. Therefore, the first device sends the first information to the second device, so that after being disconnected from the first device, the second device can quickly access the network device based on the received first information, and the second device can switch from the relay link to the direct link, thereby ensuring the service continuity.

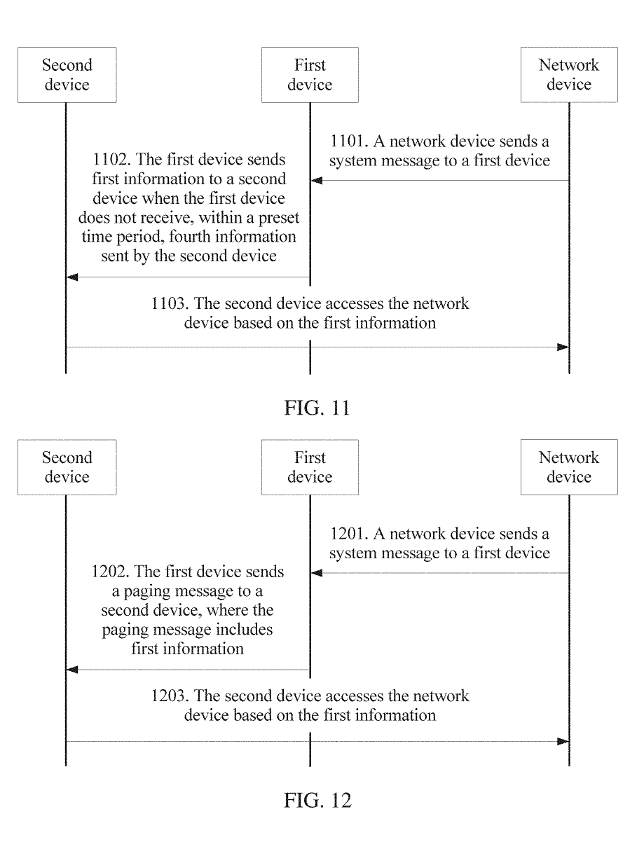

Alternatively, as shown in FIG. 11, in another embodiment of the present invention, the first device sends the first information to the second device after the first device does not receive, within a preset time period, fourth information sent by the second device. Specifically, a method shown in FIG. 11 includes the following steps.

1101. The network device sends a system message to the first device.

For example, the first device may receive the system message broadcast by the network device.

Specifically, for specific content of the system message, refer to descriptions in the existing standard, and details are not described herein.

1102. The first device sends the first information to the second device when the first device does not receive, within a preset time period, fourth information sent by the second device.

It should be understood that the fourth information is used to keep a connection between the second device and the first device. For example, the fourth information is a keep alive message (keep alive message). Step non corresponds to step 210, and for descriptions of the first information, refer to the descriptions of step 210. To avoid repetition, details are not described herein again.

1103. The second device accesses the network device based on the first information.

It should be understood that step 1103 is similar to step 220 in FIG. 2, and to avoid repetition, details are not described herein again.

Specifically, after establishing the connection to the first device, the second device sends a keep alive message, and after receiving the keep alive message, the first device returns a keep alive acknowledgement message (keep alive ACK message), to keep the connection between the first device and the second device.

If the first device does not receive, within a time period (a preset time period), the keep alive message sent by the second device, it indicates that the second device probably leaves the first device, and in this case, the first device sends the first information to the second device. Specifically, when sending the first message, the first device may use a power higher than that used to send the keep alive acknowledgement message or a modulation and coding scheme level (Modulation and Coding Scheme level) lower than that used to send the keep alive acknowledgement message, so that the second device can receive the first information. Therefore, after being disconnected from the first device, the second device can quickly access the network device based on the received first information, and the second device can switch from the relay link to the direct link, thereby ensuring the service continuity.

Alternatively, as shown in FIG. 12, in another embodiment of the present invention, the first device sends the first information to the second device when the first device pages the second device. Specifically, a method shown in FIG. 12 includes the following steps.

1201. The network device sends a system message to the first device.

For example, the first device may receive the system message broadcast by the network device.

Specifically, for specific content of the system message, refer to descriptions in the existing standard, and details are not described herein.

1202. The first device sends a paging message to the second device, where the paging message includes the first information.

Specifically, when the first device pages the second device, the first device sends the paging message to the second device. The paging message may include the first information. The paging message may further include information such as an ID of the second device. When the first device is connected to only one second device, the paging message may not include the ID of the second device, and this embodiment of the present invention is not limited thereto. For example, the paging message may be a discovery signal.

1203. The second device accesses the network device based on the first information.

It should be understood that step 1203 is similar to step 220 in FIG. 2, and to avoid repetition, details are not described herein again.

In this embodiment of the present invention, the first information is added to the paging message, so that after being disconnected from the first device, the second device can quickly access the network device based on the received first information, and the second device can switch from the relay link to the direct link, thereby ensuring the service continuity.

The foregoing describes the information transmission method in the embodiments of the present invention with reference to FIG. 1 to FIG. 12. It should be noted that examples in FIG. 1 to FIG. 12 are merely used to help a person skilled in the art to understand the embodiments of the present invention, and the embodiments of the present invention are not limited to the specific value or specific scenario in the examples. Obviously, a person skilled in the art may make any equivalent modification or change according to the examples in FIG. 1 to FIG. 12, and the modification or change also falls within the scope of the embodiments of the present invention.

It should be understood that sequence numbers of the processes do not represent an execution sequence. The execution sequence of the processes should be determined according to the functions and internal logic. The sequence numbers should not constitute any limitation to the implementation processes of the embodiments of the present invention.

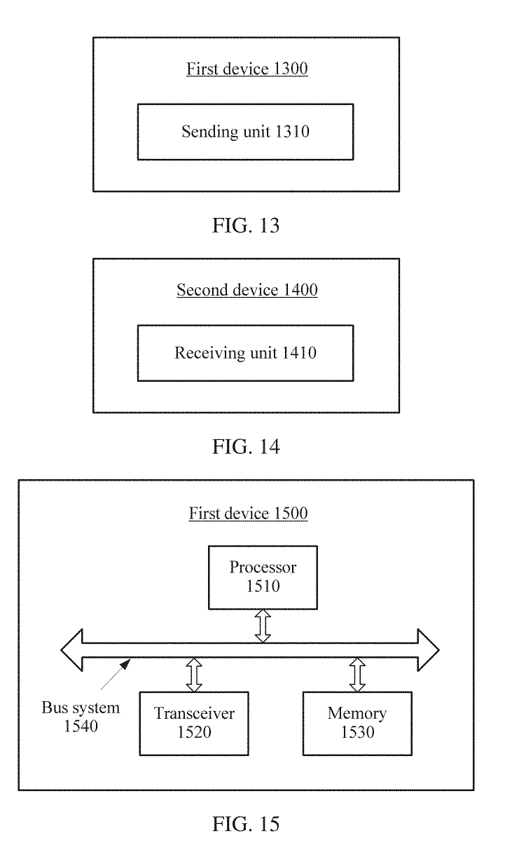

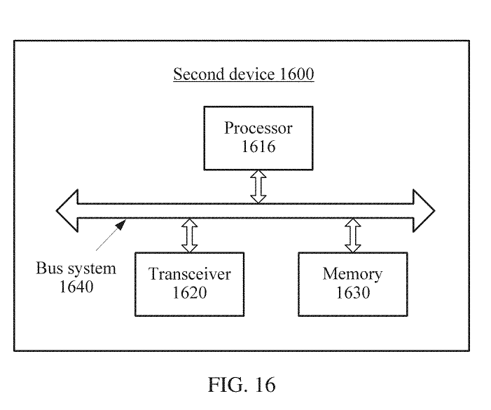

The following describes the first device in the embodiments of the present invention with reference to FIG. 13 and FIG. 15, and describes the second device in the embodiments of the present invention with reference to FIG. 14 and FIG. 16.

FIG. 13 is a schematic block diagram of a first device 1300 according to an embodiment of the present invention. Specifically, as shown in FIG. 13, the first device 1300 includes: a sending unit 1310, configured to send first information to a second device, where the first information includes a cell identity of a first cell, the first cell is a serving cell of the first device, the second device accesses the first cell by using the first device, and the first information is used by the second device to determine the cell identity of the first cell.

Therefore, in this embodiment of the present invention, the first device sends the first information to the second device, so that the second device can quickly perform cell measurement based on the first information, and quickly switch from a relay link to a direct link, thereby ensuring continuity of a service on the second device and improving user experience.

Optionally, in another embodiment, the first information is further used by the second device to access the first cell.

Optionally, in another embodiment, the second device is synchronized with the network device, and the first information further includes at least one of the following information: uplink signal timing advance TA information, time division duplex TDD system information or frequency division duplex FDD system information, a preamble sequence number used for random access, and public land mobile network PLMN identity information.

Alternatively, in another embodiment, the second device is not synchronized with the network device, the first information further includes time and frequency synchronization information; or the first information further includes time and frequency synchronization information, and at least one of the following information: TA information, a preamble sequence number used for random access, TDD system information or FDD system information, frame timing, and PLMN identity information.

Alternatively, in another embodiment, the second device is not synchronized with the network device, the first information further includes a time offset of frame timing; or the first information further includes a time offset of frame timing, and at least one of the following information: TA information, a preamble sequence number used for random access, the preamble sequence number used for random access, TDD system information or FDD system information, the frame timing, and PLMN identity information.

Optionally, in another embodiment, the first information further includes at least one of the following information: master information block MIB information and system information block type 1 SIB1 information.

Optionally, in another embodiment, the first information further includes access control information, and the access control information is used by the second device to determine to access the network device.

Optionally, in another embodiment, the sending unit is specifically configured to periodically send the first information to the second device.

Optionally, in another embodiment, the sending unit is specifically configured to send the first information to the second device based on a preset period.

Optionally, in another embodiment, the sending unit is specifically configured to send the first information to the second device based on a discontinuous reception DRX period of the first device or the second device.

Optionally, in another embodiment, the sending unit is specifically configured to send the first information to the second device in any one of the following cases: when the first device establishes a connection to the second device for pairing; when the first device performs cell handover; and when system information of the cell in which the first device is located changes.

Alternatively, in another embodiment, the first device further includes: a first receiving unit, configured to: before the sending unit sends the first information to the second device, receive second information sent by the second device, where the second information is used to request to obtain the first information; where the sending unit is specifically configured to send the first information to the second device after the first receiving unit receives the second information.

Alternatively, in another embodiment, the first device further includes: a measurement unit, configured to: before the sending unit sends the first information to the second device, measure a power of a signal of the second device, where the sending unit is specifically configured to send the first information to the second device when the power of the signal of the second device that is measured by the measurement unit is less than a first power threshold.

Alternatively, in another embodiment, the first device further includes: a second receiving unit, configured to: before the sending unit sends the first information to the second device, receive third information sent by the second device, where the third information is used to indicate a power of a signal of the first device that is measured by the second device, and the sending unit is specifically configured to send the first information to the second device when the power of the transmission signal of the first device that is measured by the second device is less than a second power threshold; or the third information is used to indicate that a power of a signal of the first device that is measured by the second device is less than the second power threshold, and the sending unit is specifically configured to send the first information to the second device after the second receiving unit receives the third information.

Alternatively, in another embodiment, the sending unit is specifically configured to send the first information to the second device when the first device does not receive, within a preset time period, fourth information sent by the second device, where the fourth information is used by the second device to keep a connection to the first device.

Alternatively, in another embodiment, the sending unit is specifically configured to send a paging message to the second device, where the paging message includes the first information.

It should be understood that the first device 1300 shown in FIG. 13 can implement various processes related to the first device in the method embodiments of FIG. 2 to FIG. 12. Operations and/or functions of the modules in the first device 1300 are separately used to implement the corresponding processes in the method embodiments of FIG. 2 to FIG. 12. For details, refer to the descriptions of the method embodiments. To avoid repetition, detailed descriptions are omitted appropriately herein.

FIG. 14 is a schematic block diagram of a second device 1400 according to an embodiment of the present invention. Specifically, as shown in FIG. 14, the second device 1400 includes: a receiving unit 1410, configured to receive first information sent by a first device, where the first information includes a cell identity of a first cell, the first cell is a serving cell of the first device, the second device accesses the first cell by using the first device, and the first information is used by the second device to determine the cell identity of the first cell.

Therefore, in this embodiment of the present invention, the second device receives the first information sent by the first device, so that the second device can quickly perform cell measurement based on the first information, and quickly switch from a relay link to a direct link, thereby ensuring continuity of a service on the second device and improving user experience.

Optionally, in another embodiment, the second device further includes: an access unit 1420, configured to access the first cell based on the first information.

Optionally, in another embodiment, the second device is synchronized with the network device, and the first information further includes at least one of the following information: uplink signal timing advance TA information, time division duplex TDD system information or frequency division duplex FDD system information, a preamble sequence number used for random access, and public land mobile network PLMN identity information.

Alternatively, in another embodiment, the second device is not synchronized with the network device the first information further includes time and frequency synchronization information; or the first information further includes time and frequency synchronization information, and at least one of the following information: TA information, a preamble sequence number used for random access, TDD system information or FDD system information, frame timing, and PLMN identity information.

Alternatively, in another embodiment, the second device is not synchronized with the network device, the first information further includes a time offset of frame timing; or the first information further includes a time offset of frame timing, and at least one of the following information: TA information, a preamble sequence number used for random access, the preamble sequence number used for random access, TDD system information or FDD system information, the frame timing, and PLMN identity information.

Optionally, in another embodiment, the first information further includes at least one of the following information: master information block MIB information and system information block type 1 SIB1 information.

Optionally, in another implementation, the first information further includes access control information, and the access control information is used by the second device to determine, based on the access control information, that the second device can access the network device; and before the second device accesses the network device based on the first information, the second device further includes: determining, by the second device based on the access control information, that the second device can access the network device.

Optionally, in another embodiment, the receiving unit is specifically configured to periodically receive the first information sent by the first device.

Optionally, in another embodiment, the receiving unit is specifically configured to receive, based on a preset period, the first information sent by the first device.

Alternatively, in another embodiment, the receiving unit is specifically configured to receive, based on a discontinuous reception DRX period of the first device or the second device, the first information sent by the first device.

Optionally, in another embodiment, the receiving unit is specifically configured to receive, in any one of the following cases, the first information sent by the first device: when the first device establishes a connection to the second device for pairing; when the first device performs cell handover; and when system information of the cell in which the first device is located changes.

Alternatively, in another embodiment, the second device further includes: a first sending unit, configured to send second information to the first device before the receiving unit receives the first information sent by the first device, where the second information is used to request to obtain the first information; where the receiving unit is specifically configured to receive the first information that is sent by the first device after the first device receives the second information.

Alternatively, in another embodiment, the receiving unit is specifically configured to receive the first information that is sent by the first device when the first device detects that a power of a signal of the second device is less than a first power threshold.

Alternatively, in another embodiment, the second device further includes: a second sending unit, configured to send third information to the first device before the receiving unit receives the first information sent by the first device, where the third information is used to indicate a power of a signal of the first device that is measured by the second device, and the receiving unit is specifically configured to receive the first information that is sent by the first device when the power of the transmission signal of the first device that is measured by the second device is less than a second power threshold; or the third indication information is used to indicate that a power of a signal of the first device that is measured by the second device is less than the second power threshold, and the receiving unit is specifically configured to receive the first information that is sent by the first device after the first device receives the third information.

Alternatively, in another embodiment, the receiving unit is specifically configured to receive the first information that is sent by the first device when the first device does not receive, within a preset time period, a fourth message sent by the second device, where the fourth information is used by the second device to keep a connection to the first device.

Alternatively, in another embodiment, the receiving unit is specifically configured to receive a paging message sent by the first device, where the paging message includes the first information.

It should be understood that the second device 1400 shown in FIG. 14 can implement various processes related to the second device in the method embodiments of FIG. 2 to FIG. 12. Operations and/or functions of the modules in the second device 1400 are separately used to implement the corresponding processes in the method embodiments of FIG. 2 to FIG. 12. For details, refer to the descriptions of the method embodiments. To avoid repetition, detailed descriptions are omitted appropriately herein.

FIG. 15 is a schematic block diagram of a first device 1500 according to an embodiment of the present invention. Specifically, as shown in FIG. 15, the first device 1500 includes a processor 1510 and a transceiver 1520. The processor 1510 is connected to the transceiver 1520. Optionally, the first device 1500 further includes a memory 1530, and the memory 1530 is connected to the processor 1510. Further optionally, the first device 1500 may further include a bus system 1540. The processor 1510, the memory 1530, and the transceiver 1520 may be connected by using the bus system 1540. The memory 1530 may be configured to store an instruction, and the processor 1510 is configured to execute the instruction stored in the memory 1530, to control the transceiver 1520 to receive and transmit information or signals.

Specifically, the controller 1510 controls the transceiver 1520 to send first information to a second device, where the first information includes a cell identity of a first cell, the first cell is a serving cell of the first device, the second device accesses the first cell by using the first device, and the first information is used by the second device to determine the cell identity of the first cell.

Therefore, in this embodiment of the present invention, the first device sends the first information to the second device, so that the second device can quickly perform cell measurement based on the first information, and quickly switch from a relay link to a direct link, thereby ensuring continuity of a service on the second device and improving user experience.

It should be understood that in this embodiment of the present invention, the processor 1510 may be a central processing unit (Central Processing Unit, “CPU” for short), or the processor 1510 may be another general purpose processor, a digital signal processor (DSP), an application-specific integrated circuit (ASIC), a field programmable gate array (FPGA) or another programmable logic device, a discrete gate or a transistor logic device, a discrete hardware component, or the like. The general purpose processor may be a microprocessor or the processor may be any conventional processor, or the like.

The memory 1530 may include a read-only memory and a random access memory, and provide an instruction and data for the processor 1510. A part of the memory 1530 may further include a non-volatile random access memory. For example, the memory 1530 may further store information about a device type.

In addition to a data bus, the bus system 1540 may further include a power bus, a control bus, a status signal bus, and the like. However, for clear description, all buses are marked as the bus system 1540 in the figure.

In an implementation process, steps of the foregoing method may be implemented by using a hardware integrated logic circuit in the processor 1510, or by using instructions in a form of software. The steps of the method disclosed with reference to the embodiments of the present invention may be directly performed by a hardware processor, or may be performed by using a combination of hardware in the processor and a software module. The software module may be located in a mature storage medium in the art such as a random access memory, a flash memory, a read-only memory, a programmable read-only memory or an electrically erasable programmable memory, or a register. The storage medium is located in the memory 1530, and the processor 1510 reads information in the memory 1530 and completes the steps of the foregoing method in combination with the hardware in the processor. To avoid repetition, details are not described herein again.

It should be understood that the first device 1500 shown in FIG. 15 can implement various processes related to the first device in the method embodiments of FIG. 2 to FIG. 12. Operations and/or functions of the modules in the first device 1500 are separately used to implement the corresponding processes in the method embodiments of FIG. 2 to FIG. 12. For details, refer to the descriptions of the method embodiments. To avoid repetition, detailed descriptions are omitted appropriately herein.

FIG. 16 is a schematic block diagram of a second device 1600 according to an embodiment of the present invention. Specifically, as shown in FIG. 16, the second device 1600 includes a processor 1610 and a transceiver 1620. The processor 1610 is connected to the transceiver 1620. Optionally, the second device 1600 further includes a memory 1630, and the memory 1630 is connected to the processor 1610. Further optionally, the second device 1600 may further include a bus system 1640. The processor 1610, the memory 1630, and the transceiver 1620 may be connected by using the bus system 1640. The memory 1630 may be configured to store an instruction, and the processor 1610 is configured to execute the instruction stored in the memory 1630, to control the transceiver 1620 to receive and transmit information or signals.

Specifically, the controller 1610 controls the transceiver 1620 to receive first information sent by a first device, where the first information includes a cell identity of a first cell, the first cell is a serving cell of the first device, the second device accesses the first cell by using the first device, and the first information is used by the second device to determine the cell identity of the first cell.

Therefore, in this embodiment of the present invention, the second device receives the first information sent by the first device, so that the second device can quickly perform cell measurement based on the first information, and quickly switch from a relay link to a direct link, thereby ensuring continuity of a service on the second device and improving user experience.

It should be understood that in this embodiment of the present invention, the processor 1610 may be a central processing unit (Central Processing Unit, “CPU” for short), or the processor 1610 may be another general purpose processor, a digital signal processor (DSP), an application-specific integrated circuit (ASIC), a field programmable gate array (FPGA) or another programmable logic device, a discrete gate or a transistor logic device, a discrete hardware component, or the like. The general purpose processor may be a microprocessor or the processor may be any conventional processor, or the like.

The memory 1630 may include a read-only memory and a random access memory, and provide an instruction and data for the processor 1610. A part of the memory 1630 may further include a non-volatile random access memory. For example, the memory 1630 may further store information about a device type.

In addition to a data bus, the bus system 1640 may further include a power bus, a control bus, a status signal bus, and the like. However, for clear description, all buses are marked as the bus system 1640 in the figure.

In an implementation process, steps of the foregoing method may be implemented by using a hardware integrated logic circuit in the processor 1610, or by using instructions in a form of software. The steps of the method disclosed with reference to the embodiments of the present invention may be directly performed by a hardware processor, or may be performed by using a combination of hardware in the processor and a software module. The software module may be located in a mature storage medium in the art such as a random access memory, a flash memory, a read-only memory, a programmable read-only memory or an electrically erasable programmable memory, or a register. The storage medium is located in the memory 1630, and the processor 1610 reads information in the memory 1630 and completes the steps of the foregoing method in combination with the hardware in the processor. To avoid repetition, details are not described herein again.

It should be understood that the second device 1600 shown in FIG. 16 can implement various processes related to the second device in the method embodiments of FIG. 2 to FIG. 12. Operations and/or functions of the modules in the second device 1600 are separately used to implement the corresponding processes in the method embodiments of FIG. 2 to FIG. 12. For details, refer to the descriptions of the method embodiments. To avoid repetition, detailed descriptions are omitted appropriately herein.

It should be understood that “one embodiment” or “an embodiment” mentioned in the whole specification means that particular features, structures, or characteristics related to the embodiment are included in at least one embodiment of the present invention. Therefore, “in one embodiment” or “in an embodiment” appearing throughout the specification does not necessarily refer to a same embodiment. In addition, these particular features, structures, or characteristics may be combined in one or more embodiments by using any appropriate manner. It should be understood that sequence numbers of the foregoing processes do not mean execution sequences in various embodiments of the present invention. The execution sequences of the processes should be determined according to functions and internal logic of the processes, and should not be construed as any limitation to the implementation processes of the embodiments of the present invention.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that in the embodiments of the present invention, “B corresponding to A” indicates that B is associated with A, and B may be determined based on A. However, it should further be understood that determining B based on A does not mean that B is determined based on A only. In addition, B may also be determined based on A and/or other information.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example based on functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the embodiments provided in the present invention, it should be understood that the disclosed system, apparatus, and method may be implemented in other manners. For example, the described apparatus embodiment is merely an example. For example, the unit division is merely logic function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected based on actual requirements to achieve the objectives of the solutions of the embodiments of the present invention.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

With descriptions of the foregoing embodiments, a person skilled in the art may clearly understand that the embodiments of the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following provides an example but does not impose a limitation: The computer-readable medium may include a RAM, a ROM, an EEPROM, a CD-ROM, or another optical disc storage or disk storage medium, or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server, or another remote source by using a coaxial cable, an optical fiber/cable, a twisted pair, a digital subscriber line (DSL), or wireless technologies such as infrared ray, radio, and microwave, the coaxial cable, optical fiber/cable, twisted pair, DSL, or wireless technologies such as infrared ray, radio, and microwave are included in fixation of a medium to which they belong. For example, a disk (Disk) and disc (disc) used in the embodiments of the present invention includes a compact disc (CD), a laser disc, an optical disc, a digital versatile disc (DVD), a floppy disk, and a Blu-ray disc. The available disk generally copies data by a magnetic means, and the disc copies data optically by a laser means. The foregoing combination should also be included in the protection scope of the computer-readable medium.

In summary, the foregoing descriptions are merely example embodiments of the technical solutions of the present invention, but are not intended to limit the protection scope of the embodiments of the present invention. Any modification, equivalent replacement, or improvement made without departing from the spirit and principle of the embodiments of the present invention shall fall within the protection scope of the embodiments of the present invention.

1. An information transmission method, comprising:
sending, by a first device, first information to a second device, wherein the first information comprises a cell identity of a first cell, the first cell is a serving cell of the first device, the second device accesses the first cell by using the first device, and the first information is used by the second device to determine the cell identity of the first cell.

2. (canceled)

3. The method according to claim 1, wherein the second device is synchronized with the network device, and the first information further comprises at least one of the following information:
uplink signal timing advance TA information, time division duplex TDD system information or frequency division duplex FDD system information, a preamble sequence number used for random access, and public land mobile network PLMN identity information.

4. (canceled)

5. The method according to claim 1, wherein the second device is not synchronized with the network device; and
the first information further comprises a time offset of frame timing; or
the first information further comprises a time offset of frame timing, and at least one of the following information:
TA information, a preamble sequence number used for random access, the preamble sequence number used for random access, TDD system information or FDD system information, the frame timing, and PLMN identity information.

6. The method according to claim 1, wherein the first information further comprises at least one of the following information:
master information block MIB information and system information block type 1 SIB1 information.

7. The method according to claim 1, wherein
the first information further comprises access control information, and the access control information is used by the second device to determine to access the network device.

8-10. (canceled)

11. The method according to claim 1, wherein
the sending, by a first device, first information to a second device comprises:
sending, by the first device, the first information to the second device in any one of the following cases:
when the first device establishes a connection to the second device for pairing;
when the first device performs cell handover; and
when system information of the cell in which the first device is located changes.

12. The method according to claim 1, wherein
before the sending, by a first device, first information to a second device, the method further comprises:
receiving, by the first device, second information sent by the second device, wherein the second information is used to request to obtain the first information; and
the sending, by a first device, first information to a second device comprises:
sending, by the first device, the first information to the second device after receiving the second information.

13-32. (canceled)

33. A first device, comprising:
a transmitter, configured to send first information to a second device, wherein the first information comprises a cell identity of a first cell, the first cell is a serving cell of the first device, the second device accesses the first cell by using the first device, and the first information is used by the second device to determine the cell identity of the first cell.

34. (canceled)

35. The first device according to claim 33, wherein the second device is synchronized with the network device, and the first information further comprises at least one of the following information:
uplink signal timing advance TA information, time division duplex TDD system information or frequency division duplex FDD system information, a preamble sequence number used for random access, and public land mobile network PLMN identity information.

36. (canceled)

37. The first device according to claim 33, wherein the second device is not synchronized with the network device; and
the first information further comprises a time offset of frame timing; or
the first information further comprises a time offset of frame timing, and at least one of the following information:
TA information, a preamble sequence number used for random access, the preamble sequence number used for random access, TDD system information or FDD system information, the frame timing, and PLMN identity information.

38. The first device according to claim 33, wherein the first information further comprises at least one of the following information:
master information block MIB information and system information block type 1 SIB1 information.

39. The first device according to claim 33, wherein
the first information further comprises access control information, and the access control information is used by the second device to determine to access the network device.

40-42. (canceled)

43. The first device according to claim 33, wherein
the transmitter is specifically configured to send the first information to the second device in any one of the following cases:
when the first device establishes a connection to the second device for pairing;
when the first device performs cell handover; and
when system information of the cell in which the first device is located changes.

44. The first device according to claim 33, wherein the first device further comprises:
a receiver, configured to: before the transmitter sends the first information to the second device, receive second information sent by the second device, wherein the second information is used to request to obtain the first information; wherein
the transmitter is specifically configured to send the first information to the second device after the first receiving unit receives the second information.

45-64. (canceled)

65. A computer-readable storage medium, wherein the storage medium stores at least one instruction for instructing a computer device to perform the following:
sending, by a first device, first information to a second device, wherein the first information comprises a cell identity of a first cell, the first cell is a serving cell of the first device, the second device accesses the first cell by using the first device, and the first information is used by the second device to determine the cell identity of the first cell.

66. The storage medium according to claim 65, wherein the second device is synchronized with the network device, and the first information further comprises at least one of the following information:
uplink signal timing advance TA information, time division duplex TDD system information or frequency division duplex FDD system information, a preamble sequence number used for random access, and public land mobile network PLMN identity information.

67. The storage medium according to claim 65, wherein the second device is not synchronized with the network device; and
the first information further comprises a time offset of frame timing; or
the first information further comprises a time offset of frame timing, and at least one of the following information:
TA information, a preamble sequence number used for random access, the preamble sequence number used for random access, TDD system information or FDD system information, the frame timing, and PLMN identity information.

68. The storage medium according to claim 65, wherein the first information further comprises at least one of the following information:
master information block MIB information and system information block type 1 SIB1information.

69. The storage medium according to claim 65, wherein
the first information further comprises access control information, and the access control information is used by the second device to determine to access the network device.

70. The storage medium according to claim 65, wherein
the sending, by a first device, first information to a second device comprises:
sending, by the first device, the first information to the second device in any one of the following cases:
when the first device establishes a connection to the second device for pairing;
when the first device performs cell handover; and
when system information of the cell in which the first device is located changes.
